(19) United States
(12) Patent Application Publication
(10) Pub. No.: US 2010/0308288 A1
(43) Pub. Date: Dec. 9, 2010

(54) EXTRACTION DEVICE

(75) Inventor: Mark Vincent, Leighton Buzzard (GB)

Correspondence Address: KNOBBE MARTENS OLSON & BEAR LLP, 2040 MAIN STREET, FOURTEENTH FLOOR, IRVINE, CA, 92614, US

(73) Assignee: PYROTEK ENGINEERING MATERIALS LIMITED, Milton Keynes (GB)

(21) Appl. No.: 12/682,229

(22) PCT Filed: Oct. 6, 2008
(86) PCT No.: PCT/GB08/03380

§ 371 Date: Jul. 30, 2010

(30) Foreign Application Priority Data
Oct. 12, 2007 (GB) 0719981.3

(51) Int. Cl. B66F 3/00

(52) U.S. Cl. 254/133 R

(57) ABSTRACT

An extraction device is provided for use when extracting a ceramic foam filter, as used for example in the production and processing of aluminium. The extraction device includes an anchor device (3) suitable for driving into the filter, said anchor device (3) having an anchor body (5) with a leading end and a trailing end, a screw thread (13) for engagement with the filter and a substantially pointed part (7) at the leading end for piercing a surface of the filter.

The present invention relates to an extraction device for use when extracting a ceramic foam filter, as used for example in the production and processing of aluminium and other metals.

Molten aluminium usually has to be filtered before it is cast. The filtration process removes particles that could otherwise cause rejects in the final products.

Traditionally, ceramic foam filters are used. These are made from alumina refractory slurry by impregnating a reticulated foam manufactured to a specific porosity with the slurry. The impregnated foam is then dried and fired in a kiln. The foam burns off leaving a porous ceramic body, which is used as the filter. Ceramic filters come in various sizes, typically 7″, 9″, 12″, 15″, 17″, 20″, 23″ and 26″ square, and 2″ thick (16 cm, 20 cm, 27 cm, 34 cm, 38 cm, 45 cm, 52 cm and 58 cm square, and 5 cm thick).

For use, the filter is mounted in a refractory filter bowl. Liquid aluminium is poured into the bowl through the filter, which traps fine particles in the liquid metal. When the casting operation is complete, the aluminium remaining within the ceramic filter freezes, forming a block of virtually solid aluminium.

After use, the filter must be removed and replaced before the next casting operation. Current industrial practice to remove the filter is to stab a hole in the filter while it is still full of liquid aluminium with a hooked steel bar. The aluminium is then allowed to freeze, after which the filter is pulled out using the bar. This is not however a very elegant or safe solution, as liquid metal can splash out when puncturing the filter. The refractory bowl that houses the filter may also be damaged if the steel bar passes through the filter and jabs the base. Broken filter parts can also sometimes get washed into the next cast.

WO 2007/012795 describes a filter extraction device including a threaded anchor that may be screwed in the filter, allowing it to be extracted more safely and avoiding the risk of damaging the bowl. This device therefore addresses the above-mentioned problems to some extent. However, we have found that there is still a tendency for users to stab the anchor violently into the filter, which can cause the anchor to break. Also, the design of the anchor is such that it takes a relatively long time to insert fully, which increases the operator's exposure to the heat radiated from the filter and the associated equipment.

Also, the filters are brittle and have a tendency to disintegrate when devices are inserted into them.

Accordingly invention seeks to provide a filter extraction device and a method of extracting a filter that mitigates at least one of the aforesaid disadvantages or at least provides an alternative solution.

According to the present invention there is provided an extraction device for use when extracting a ceramic foam filter, the extraction device including an anchor device suitable for driving into the filter, said anchor device having an anchor body with a leading end and a trailing end, a screw thread for engagement with the filter and a substantially pointed part at the leading end for piercing a surface of the filter.

The extraction device according to the invention is easier to insert into the filter than the device described in WO 2007/012795.

The extraction device may be used to extract a used ceramic foam filter safely and efficiently. Because the filter is not broken violently, there is no significant risk of liquid aluminium being splashed out of the filter or the filter bowl, and very little or no loose debris will be created, so reducing the risk of contaminating a subsequent batch of aluminium. The extraction device locks firmly into the filter, reducing the risk of it being dropped.

Advantageously the outer diameter of the screw thread can vary along its length, for example such that the outer diameter of the screw thread increases from the leading end to the trailing end. The increase in diameter is preferably smooth and uniform. Thus the outer diameter of the screw thread is at a maximum towards the trailing end and a minimum towards the leading end. This provides a substantially tapered anchor device, for example a substantially conical anchor device, which enables the anchor device to be inserted into the filter more easily and further reduces the amount of molten metal splashed on insertion.

Typically the maximum diameter of the screw thread is in the range approximately 20-100 mm, and preferably approximately 50-80 mm.

Advantageously the pointed part can be an integral part of the anchor body. Preferably the screw thread extends from the pointed part of the anchor body along at least a substantial portion of the length of the body, for example around 50-100% of the length of the body.

Typically the anchor body has a maximum diameter in the range 10-40 mm, preferably in the range 15-30 mm, and more preferably approximately 15-25 mm.

Advantageously the extraction device can include a helical groove formed in the anchor body for engagement with the filter, wherein the radial depth of the groove varies along the length of the body. Advantageously the radial depth of the groove varies such that it increases from the trailing end towards the leading end. The radial depth of the groove is at a minimum towards the trailing end and a maximum towards the leading end. This has the effect of reducing the diameter of the body along the length of the anchor device, which reduces the resistance of the body to insertion into the filter and provides additional grip when inserted.

Typically the maximum radial depth of the screw thread is in the range 10-45 mm, and is preferably approximately 15-30 mm.

Advantageously the screw thread can have an upper surface that extends substantially perpendicularly from the anchor body. The screw thread can have a lower surface that extends from the anchor body such that it is inclined to the anchor body or can have a lower surface that extends substantially perpendicularly from the anchor body.

In one preferred embodiment, the screw thread has a substantially triangular cross-section that tapers from a root portion at the body to a sharp cutting edge. It has been found that anchor devices having screw threads with this arrangement cut into the filter more easily. Advantageously the thickness of the screw thread at the root is in the range 1-10 mm, preferably in the range 1-6 mm and more preferably still around 2-4 mm. This gives the anchor device low resistance when cutting into the filter and helps to prevent the filter from disintegrating on insertion.

In another preferred embodiment the screw thread includes a side wall, and the side wall is inclined to the longitudinal axis of the anchor device. This provides the anchor device with tapering sides and thus a substantially conical shape, which facilitates easier penetration of the filter device. Advantageously the thickness of the screw thread is in the range 10-30 mm, preferably 15-25 mm and more preferably still around 17-20 mm. This gives the anchor device significant strength, which enables it to withstand the thermal and mechanical stresses involved in the filter extraction operation. The thickness of a turn on the screw thread can be reduced if the screw thread is truncated.

Advantageously the screw thread comprises from one to four turns, and preferably one to three turns. We have found that a screw thread with only a few widely spaced turns provides a much stronger connection with the rather crumbly material of the ceramic foam filter than a thread with more closely spaced turns.

Advantageously the screw thread can have a substantially constant pitch in the range 5-45 mm, preferably 10-40 mm and more preferably still around 15-35 mm. Having a large pitch means that a significant amount of the filter material sits between each turn of the thread, which provides a good mechanical interlock. The constant pitch helps to cut a smooth helical path into the filter. The smooth helical path allows the anchor device to be unscrewed from the filter. A long pitch and a short length anchor device having few turns allows the device to be inserted quickly into the filter.

Advantageously the screw thread can have an overall length that is less than or equal to the depth of the filter. For a filter having a 50 mm thickness length is typically in the range 40-48 mm, and preferably around 45 mm, but may be in the range 20-48 mm. This ensures that when the anchor device is inserted into the filter to its full depth, it does not break through the opposite side of the filter, thereby preventing debris from falling into the filter bowl.

Advantageously the extraction device can be made from carbon steel. Alternatively, it may be made from stainless steel, an aluminium alloy or another suitable material.

Advantageously the extraction device includes lifting means. Advantageously the lifting means can be releaseably connectable to the anchor device. Preferably the lifting means comprises a detachable handle that can be screwed to the anchor device. Alternatively, some other kind of connection means may be provided, for example a bayonet connector.

According to another aspect of the invention there is provided a method of extracting a ceramic foam filter, the method including screwing an extraction device into the filter, and lifting the extraction device to extract the filter, said extraction device being in accordance with any one of the preceding statements of invention, or any combination thereof.

Embodiments of the invention will now be described by way of example only, with reference to the accompanying drawings, in which:

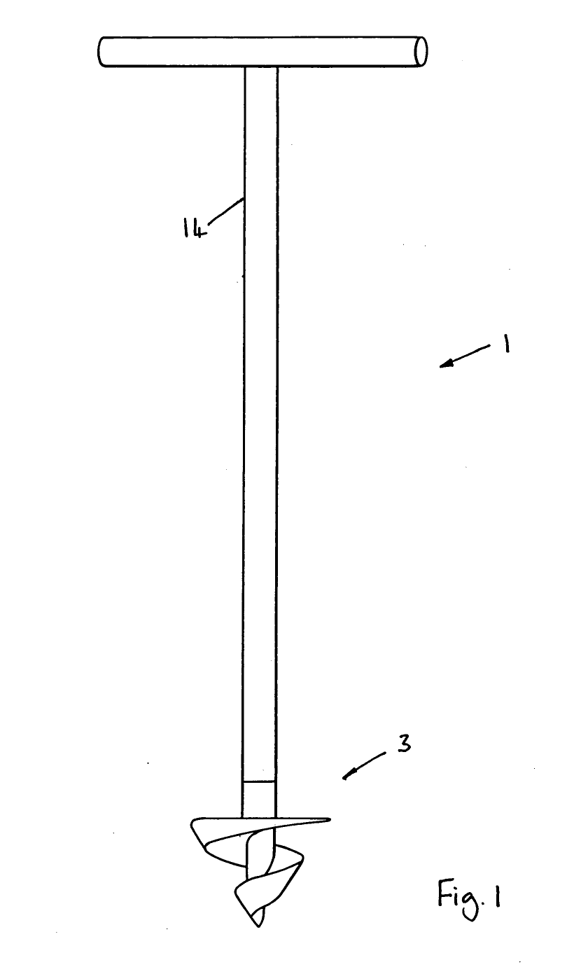

FIG. 1 shows a first embodiment of an extraction device according to the invention, which includes an anchor member;

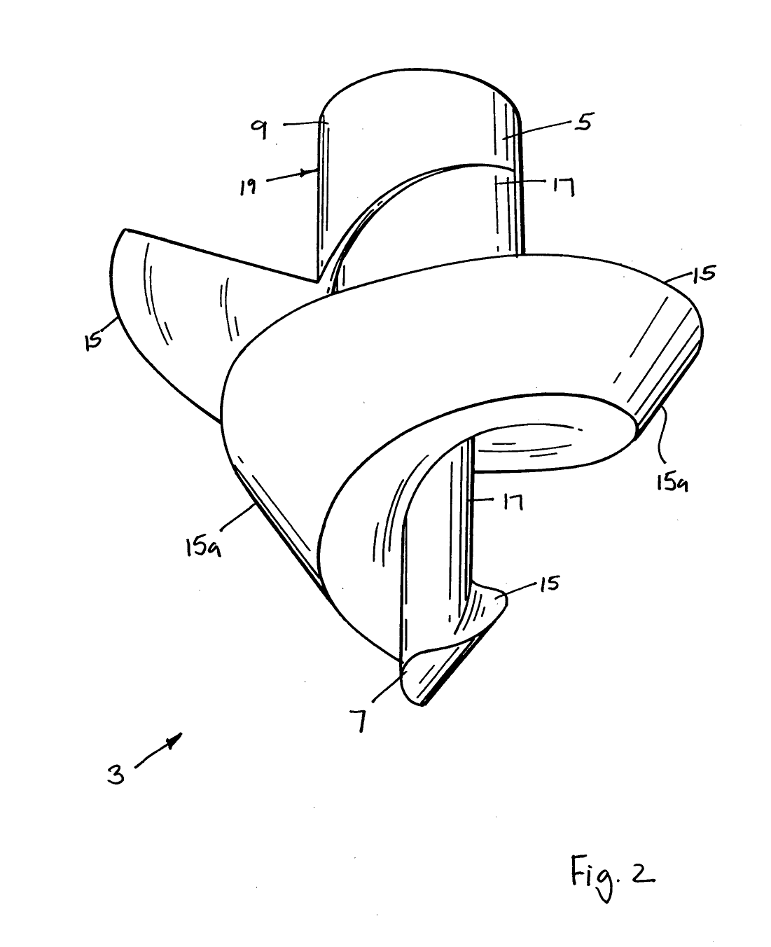

FIG. 2 is a perspective view from below of the anchor member;

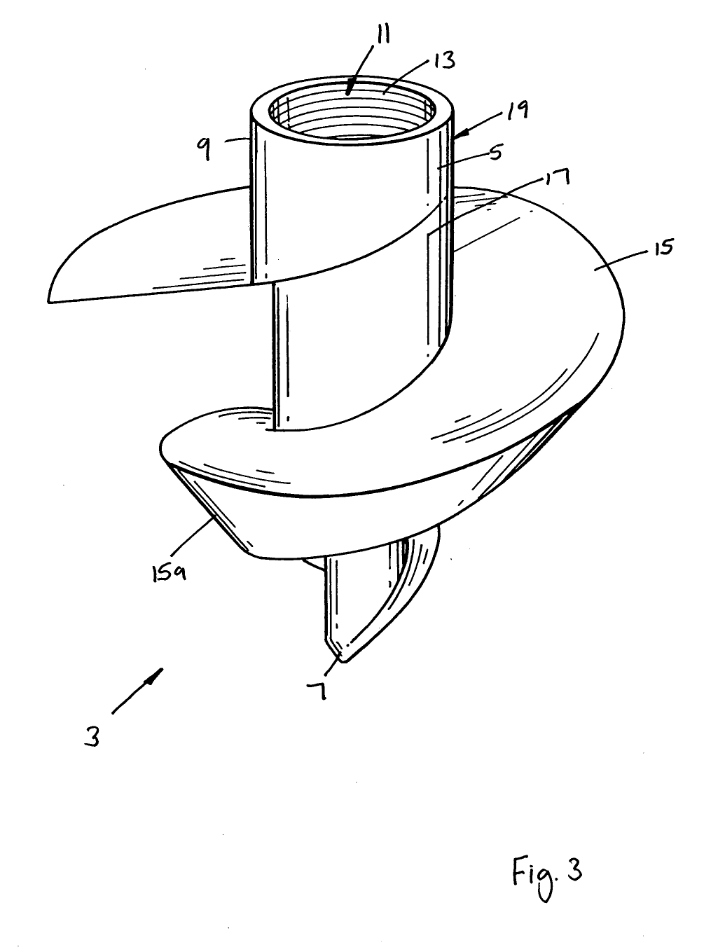

FIG. 3 is a perspective view from above of the anchor member;

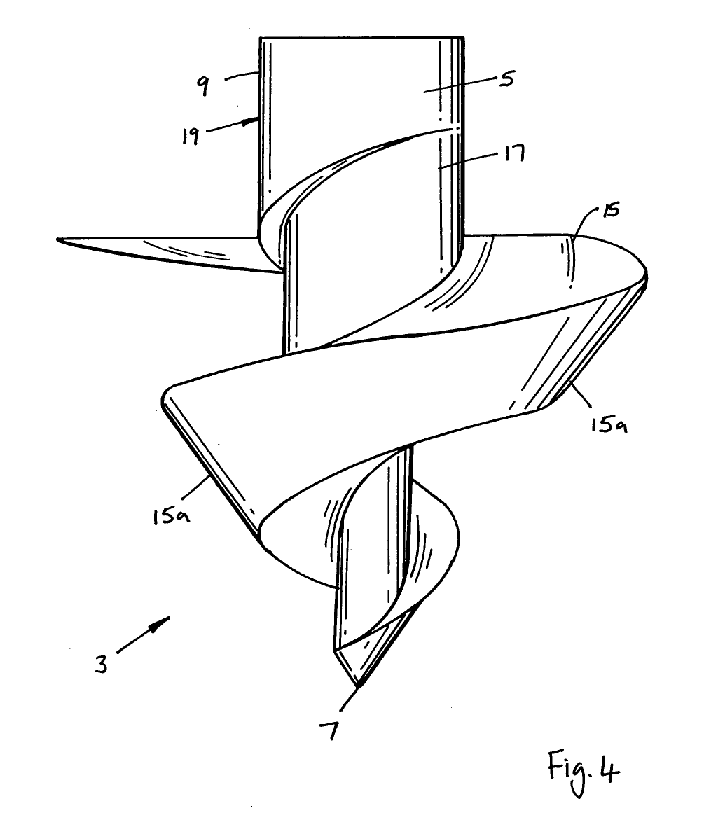

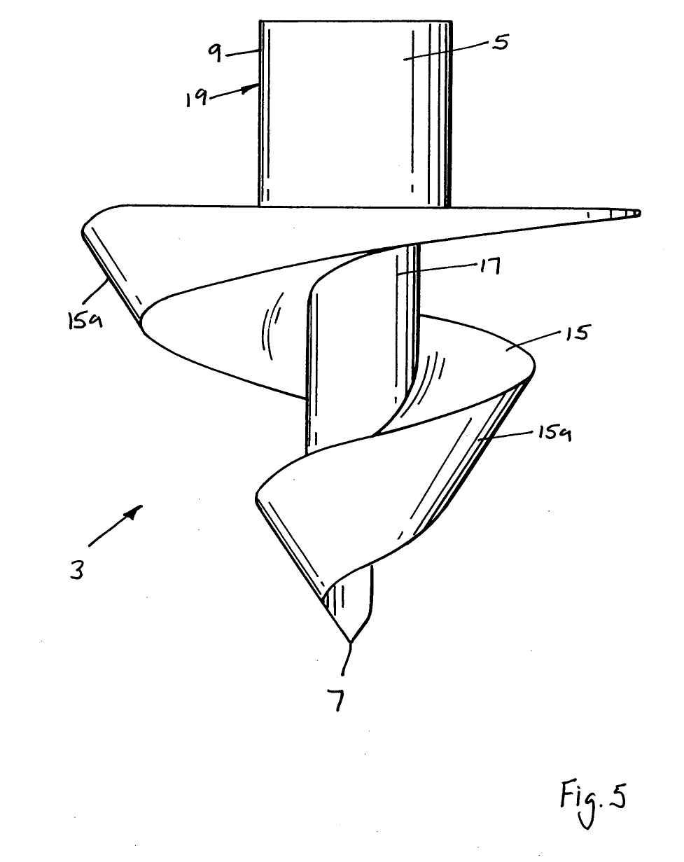

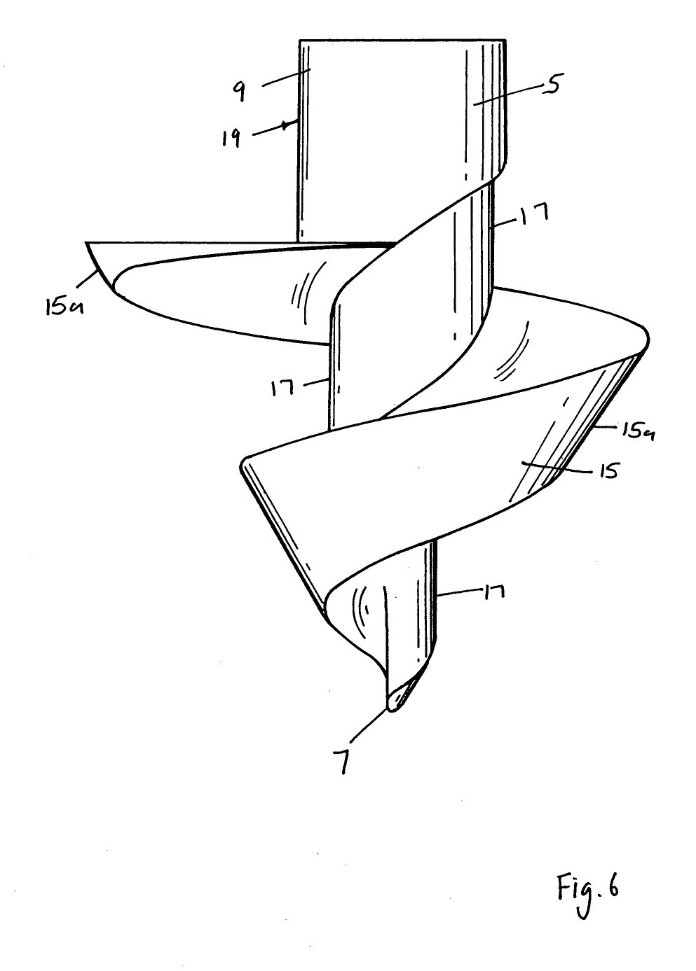

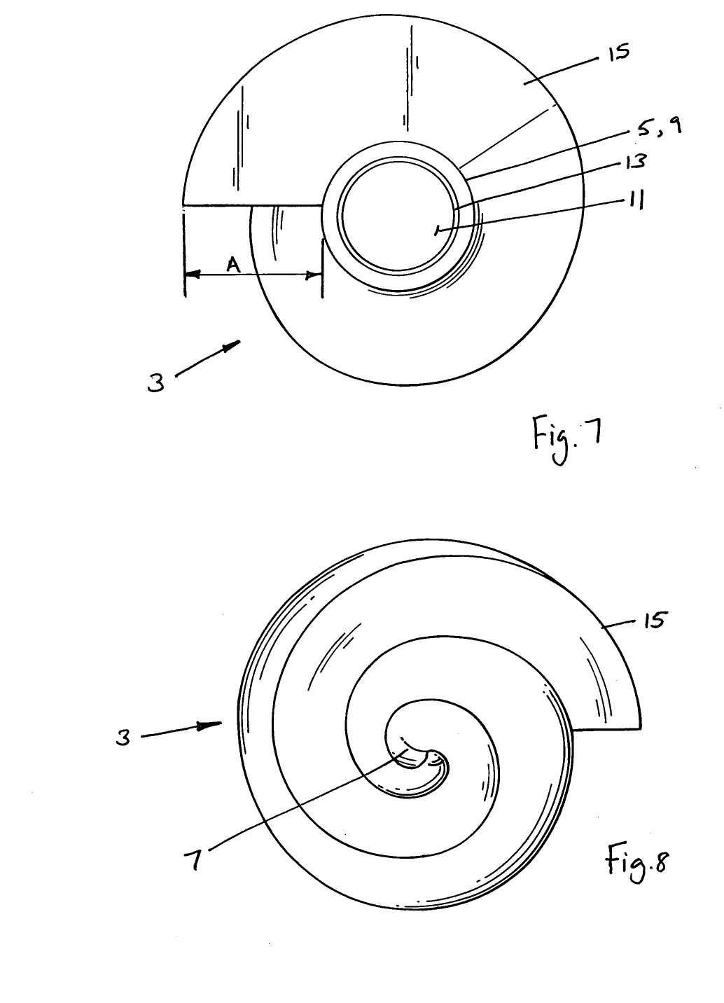

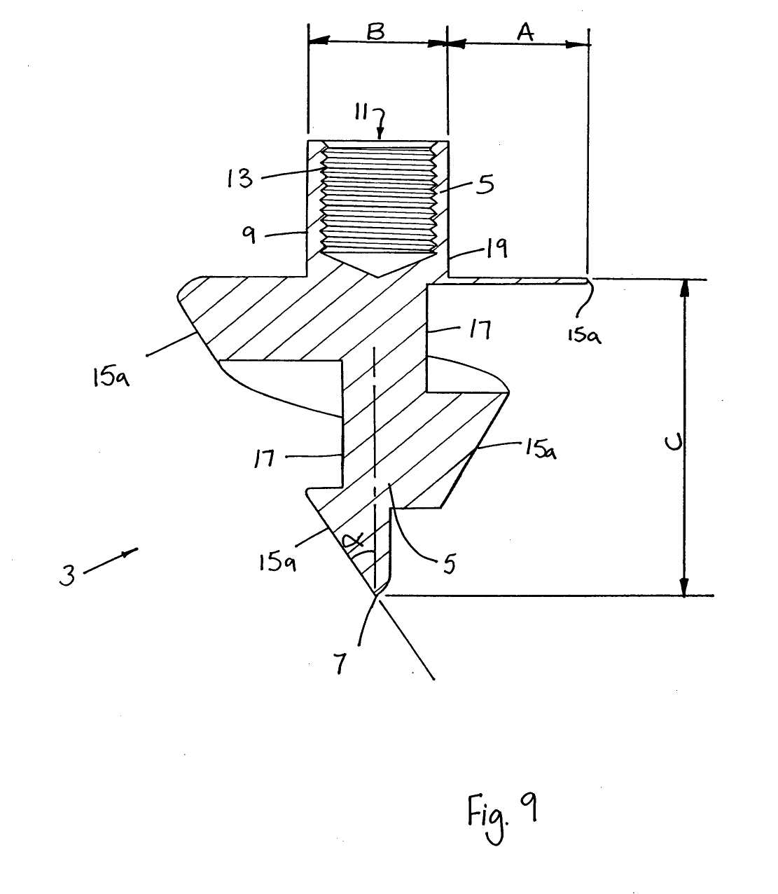

FIGS. 4 to 6 are side views of the anchor member in alternative rotational orientations about a longitudinal axis;

FIG. 7 is a plan view of the anchor member from above;

FIG. 8 is a plan view of the anchor member from below;

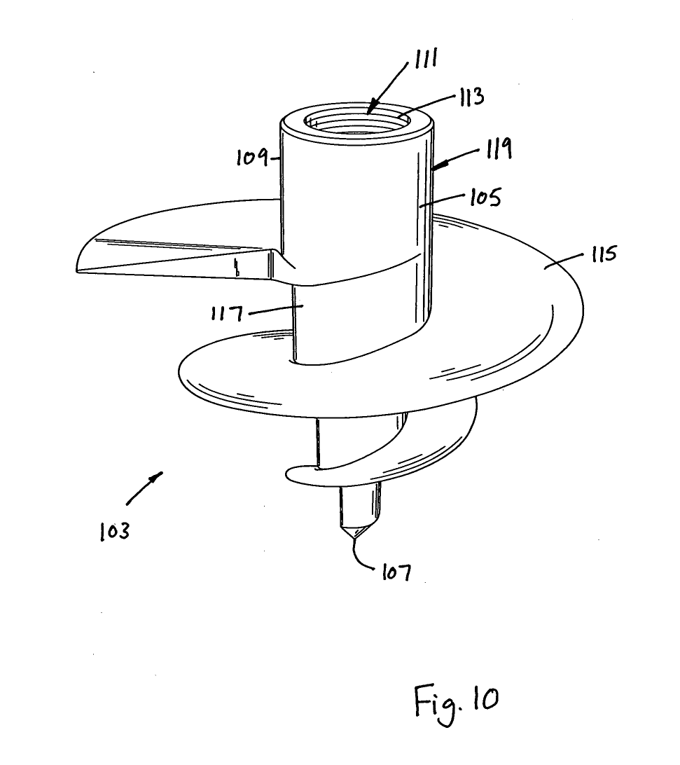

FIG. 9 is a cross-section of the anchor member; and

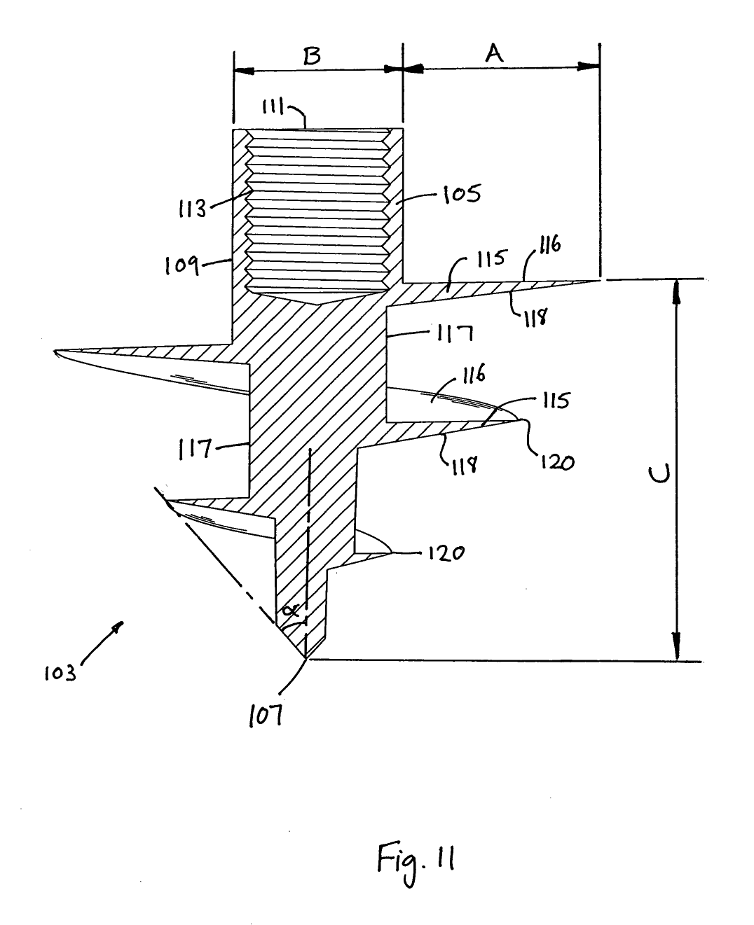

FIG. 10 is a perspective view from above of a anchor member for a second extraction device according to the invention; and

FIG. 11 shows a cross-section of the anchor device of FIG. 10.

A first extraction tool 1 for removing a ceramic filter from a mould is shown in FIGS. 1 to 9, which includes an anchor member 3 comprising a body 5 having a pointed tip 7 at one end of the body and a connector portion 9 including a cylindrical bore 11 at the other end of the body. The bore 11 is provided with an M16 internal screw thread 13 (see FIG. 9) for forming a connection with a lifting tool 14. The lifting tool 14 may, for example, consist of a detachable handle such as a T-bar having a complementary external M16 screw thread (not shown) at one end for engagement with the internal screw thread 13. The lifting tool 14 additionally, or alternatively, may include a lifting eye for connection to a hoist or other lifting mechanism.

The anchor member 3 has an external helical screw thread 15 that extends outwards from the body 5. The radial depth of the screw thread A, and hence the effective outer diameter of the anchor member 3, reduces from a maximum at the connector portion 9 to a minimum at the tip 7. This, together with an inclined side wall 15a, defines a substantially conical outer profile. Preferably the radial depth of the screw thread A adjacent the connector portion 9 is around 20 mm (see FIGS. 8 and 9). The side wall 15a is inclined to the longitudinal axis of the anchor member 3 by an angle α, which is approximately 35 degrees.

The screw thread 15 extends along a substantial part of the length of the body, typically around 80% of the length from the tip 7, and includes approximately 1½ widely spaced turns. The screw thread 15 has a constant pitch of about 34 mm and a thread thickness of around 15 mm. The thickness of the thread towards the connector portion 9 is reduced since the screw thread 15 is truncated.

The body 5 includes a helical groove 17 formed in its outer curved surface 19 that extends along a substantial part of the length of the body 5, typically around 80% of the length of the body 5 from the tip 7. Thus the body 5 has a substantially circular cross-section along its length however the diameter of the body 5 reduces along the length of the body 5 from a maximum B at the connector portion 9 to a minimum at the tip 7. The diameter of the tip 7 is typically around 3 mm to 8 mm, and preferably around 5 mm. Thus the helical groove 17 reduces the diameter of the body 5 such that the tip 7 is only around 25% of the maximum diameter of the body B. Since the body 5 has a reduced diameter around the tip 7 it is easier for the anchor to penetrate the filter and thereby reduces the amount of splashing of molten metal.

The body 5 has a maximum diameter B of approximately 19 mm, so that the maximum overall diameter of the extraction tool is approximately 56 mm. The screw thread 15 has a length C of less than 45 mm from the tip 7 to the upper most point of the external screw thread 15. This prevents the anchor from piercing the filter when fully inserted. Preferably the extraction tool 1 is made from carbon steel to resist abrasion from the filter material.

In use, the lifting tool 14 is connected to the anchor member 3, by being screwed into the threaded bore 11 at the upper end of the body to form the extraction tool 1. Then, while the aluminium within the filter is still in a liquid state, the extraction tool 1 is driven into the upper face of the ceramic foam filter by initially stabbing the pointed tip 7 into the surface of the filter and then rotating the extraction tool 1. The screw thread 15 cuts a helical path into the filter thereby locking the extraction tool 1 into the filter. The extraction tool 1 is driven into the filter until the anchor member 3 is fully embedded and the top of the external screw thread 15 is flush with the top surface of the filter. As the length of the screw thread 15 is slightly less than the thickness of the filter, it will not break through the lower face of the filter, thereby preventing debris from falling into the filter bowl.

The pointed tip 7, and to some extent the varying outer diameter of the external screw thread 15, enables the extraction tool 1 to be more easily inserted into the filter. This is particularly useful to prevent molten metal from splashing at the time of piercing the filter. The low number of thread turns and the large pitch retain the integrity of the filter during the insertion process. It also means that the device can be fully inserted more quickly than the prior art device disclosed in WO 2007/012795 since full insertion is achieved by rotating the device less than two turns. This is advantageous to the operators who want minimal operation times due to the hazards of working with molten metal. The thickness of the thread 15 provides the strength required to withstand the impact force and the thermal stresses when the extraction tool 1 is inserted into the filter. It also enables the anchor member 3 to be produced by lost wax casting.

The extraction tool 1 is left in the filter until the retained aluminium has solidified: this further increases the mechanical interlock between the anchor member 3 and the filter. The filter is then extracted from the filter bowl by lifting the extraction tool 1. The filter can therefore be removed easily and cleanly, without leaving debris in the filter bowl and without giving rise to a risk of liquid aluminium being splashed out of the filter. A new filter can then be placed in the filter bowl so that it is ready for another casting operation.

The lifting tool 14 can be detached from the anchor member 3 for re-use, whereas typically the anchor member 3 remains in the filter.

It will be appreciated that modifications can be made to the above embodiment that fall within the scope of the invention, for example dimensions of the device may vary as follows: the screw thread can have 1 to 3 turns, the maximum thickness of the screw thread is typically in the range 10-30 mm.

Part of a second embodiment of the invention is shown in FIGS. 10 and 11. The second embodiment is similar to the first embodiment in that it includes an anchor member 103 comprising a body 105 having a pointed tip 107 at one end of the body and a connector portion 109 including a cylindrical bore 111 at the other end of the body. The bore 111 is provided with an M16 internal screw thread 113 1 for forming a connection with a lifting tool (not shown) that is similar to that shown in FIG. 1. The lifting tool may, for example, consist of a detachable handle such as a T-bar having a complementary external M16 screw thread (not shown) at one end for engagement with the internal screw thread 113. The lifting tool additionally, or alternatively, may include a lifting eye for connection to a hoist or other lifting mechanism.

The anchor member 103 has an external helical screw thread 115 that extends outwards from the body 105. The radial depth of the screw thread A, and hence the effective outer diameter of the anchor member 103, reduces from a maximum at the connector portion 109 to a minimum at the tip 107. This defines a substantially conical outer profile having an angle of inclination to the longitudinal axis of the body α, which is approximately 40 degrees. Preferably the radial depth of the screw thread A adjacent the connector portion 109 is around 20 mm.

The screw thread 115 extends along a substantial part of the length of the body, typically around 80% of the length from the tip 7, and includes approximately three widely spaced turns. The screw thread 115 has a substantially triangular cross-section having an upper surface 116 (the surface facing towards the connector portion 109) arranged to extend substantially perpendicularly from the body 105 and a lower surface 118 that is inclined to the body 105, wherein the meeting of the upper and lower surfaces 116,118 defines a sharp cutting edge 120. The inventors have found that this form of thread cuts more easily into the filter, which assists the user to insert the device without being splashed by molten metal since the extraction device can be turned with less force and more smoothly. The screw thread 115 has a substantially constant pitch of about 17 mm and a substantially constant thread thickness of around 3 mm at the root. The large pitch and relatively thin thread thickness allows a significant portion of filter material to move between the threads during insertion (or extraction), which prevents the filter from disintegrating when the extraction tool is inserted (or extracted). Since the screw thread 115 has a substantially constant pitch and a substantially constant thread thickness it cuts a helical path into the filter, which remains substantially in tact after insertion. This has the advantages of allowing the extraction device to be unscrewed from the filter without the filter disintegrating and also ensuring that the extraction device has a good mechanical interlock on the filter so that the filter can be successfully lifted from the mould.

The body 105 has a maximum diameter B of approximately 21 mm, so that the maximum overall diameter of the extraction tool is approximately 80 mm. The screw thread 115 has a length C of around 48 mm from the tip 107 to the upper most point of the external screw thread 115. This prevents the anchor from piercing the filter when fully inserted.

The body 105 includes a helical groove 117 formed in its outer curved surface 119 that extends along a substantial part of the length of the body 105, typically around 80% of the length of the body 105 from the tip 107. Thus the body 105 has a substantially circular cross-section along its length however the diameter of the body 105 reduces along the length of the body 105 from a maximum B at the connector portion 109 to a minimum at the tip 107. The diameter of the tip 107 is typically around 3 mm to 8 mm, and preferably around 5 mm. Thus the helical groove 117 reduces the diameter of the body 105 such that the tip 107 is only around 25% of the maximum diameter of the body B. Since the body 105 has a reduced diameter around the tip 107 it is easier for the anchor to penetrate the filter and thereby reduces the amount of splashing of molten metal.

Preferably the extraction tool 101 is made from carbon steel to resist abrasion from the filter material. The anchor 103 can be made by casting or can be machined.

The method of connecting the lifting tool to the anchor 103, and the use of the extraction device, is similar to that described for the first embodiment.

It will be appreciated that modifications can be made to the second embodiment that fall within the scope of the invention, for example dimensions of the device may vary as follows: the screw thread typically has 2 to 4 turns, and the maximum thickness of the screw thread is typically in the range 1-10 mm.

It will be appreciated that modifications can be made to the above embodiments that fall within the scope of the invention, for example dimensions of the device may vary as follows: the screw thread can have 1 to 4 turns, the screw thread typically extends along 50-100% of the length of the anchor from the tip however it may extend over a shorter portion if necessary, the angle α is typically in the range 15-60°, and is preferably around 30-45°, the maximum outside diameter is typically in the range 40-100 mm, the maximum radial depth of the screw thread is typically in the range 10-45 mm, the anchor body has a maximum diameter that is typically in the range 15-30 mm, the screw thread has a pitch that is typically in the range 5-40 mm, and the screw thread has an overall length that is typically less than or equal to 45 mm for filters having a depth of 45 mm, and is preferably in range 20-45 mm.

If the depth of the filter is greater than 45 mm, the length of the screw thread 15 can be increased provided that it does not penetrate the lower side of the filter. Other dimensions can be scaled accordingly.

1. An extraction device for use when extracting a ceramic foam filter, the extraction device including an anchor device suitable for driving into the filter, said anchor device having an anchor body with a leading end and a trailing end, a screw thread for engagement with the filter and a substantially pointed part at the leading end for piercing a surface of the filter.

2. The extraction device according to claim 1, wherein the outer diameter of the screw thread varies along its length.

3. The extraction device according to claim 2, wherein the outer diameter of the screw thread increases from a minimum at the leading end to a maximum at the trailing end.

4. The extraction device according to claim 1, wherein the maximum diameter of the screw thread is in the range of 20-100 mm.

5. The extraction device according to claim 1, wherein the pointed part is an integral part of the anchor body.

6. The extraction device according to claim 1, further comprising a helical groove formed in the anchor body for engagement with the filter.

7. The extraction device according to claim 6, wherein the radial depth of the groove varies along the length of the body.

8. The extraction device according to claim 7, wherein the radial depth of the groove increases from the trailing end towards the leading end, thereby reducing the diameter of the body from a maximum at the trailing end to a minimum at the leading end.

9. The extraction device according to claim 1, wherein the maximum radial depth of the screw thread is in the range of 10-45 mm.

10. The extraction device according to claim 1, wherein anchor body has a maximum diameter in the range 13-22 mm.

11. The extraction device according to claim 1, wherein the screw thread has an upper surface that extends substantially perpendicularly from the anchor body.

12. The extraction device according to claim 1, wherein the screw thread has a lower surface that extends from the anchor body such that it is inclined to the anchor body.

13. The extraction device according to claim 1, wherein the screw thread has a substantially triangular cross-section and is arranged to taper from a root portion at the body to a sharp cutting edge.

14. The extraction device according to claim 1, wherein the screw thread has a side wall, and the side wall is inclined to the longitudinal axis of the anchor device.

15. The extraction device according to claim 1, wherein the screw thread has a lower surface that extends substantially perpendicularly from the anchor body.

16. The extraction device according to claim 1, wherein the thickness of the screw thread is in the range of 1-30 mm.

17. The extraction device according to claim 1, wherein the screw thread comprises from one to four turns.

18. The extraction device according to claim 1, wherein the screw thread has a pitch in the range 5-45 mm.

19. The extraction device according to claim 1, wherein the screw thread has an overall length that is less than or equal to 48 mm.

20. The extraction device according to claim 1, wherein the extraction device is made from carbon steel.

21. The extraction device according to claim 1, further including lifting means.

22. The extraction device according to claim 21, wherein the lifting means is releaseably connectable to the anchor device.

23. A method of extracting a ceramic foam filter, the method including screwing an extraction device according to claim 1 into the filter, and lifting the extraction device to extract the filter.
